(19) United States
(12) Patent Application Publication
(10) Pub. No.: US 2025/0090402 A1
(43) Pub. Date: Mar. 20, 2025

(54) MASSAGE APPARATUS CAPABLE OF ADJUSTING POSITION OF ARM MASSAGE UNIT

(71) Applicant: BODYFRIEND CO., LTD., Seoul (KR)

(72) Inventor: Ik Ju JEONG, Seoul (KR)

(21) Appl. No.: 18/436,958

(22) Filed: Feb. 8, 2024

(30) Foreign Application Priority Data
Sep. 14, 2023 (KR) 10-2023-0122714

(51) Int. Cl. A61G 15/00; A61G 15/02; A61G 15/12

(52) U.S. Cl. CPC A61G 15/007; A61G 15/02; A61G 15/12; A61G 2200/34

(57) ABSTRACT

A massage apparatus capable of adjusting the position of an arm massage unit includes a body massage unit configured to massage at least a part of a body of a user, the arm massage unit disposed on a side portion of the body massage unit and configured to massage an arm of the user, and a lifting and lowering unit disposed on a lower portion of the arm massage unit and configured to adjust a position of the arm massage unit.

### CROSS-REFERENCE TO RELATED APPLICATION

This application is based on and claims priority under 35 U.S.C. § 119 to Korean Patent Application No. 10-2023-0122714, filed on Sep. 14, 2023, in the Korean Intellectual Property Office, the disclosure of which is incorporated by reference herein in its entirety.

### BACKGROUND

### 1. Field

The present disclosure relates to a massage apparatus capable of adjusting the position of an arm massage unit, and more particularly, to a massage apparatus capable of changing the height and inclination of an arm massage unit to ensure that the arm of a user using the massage apparatus is in an ergonomically comfortable position.

### 2. Description of the Related Art

Massage is a medical adjuvant therapy that regulates modulation of the body of a subject, assists in blood circulation, and relieves fatigue of the subject by applying various types of dynamic stimulation to a part of the body, such as kneading, pressing, pulling, tapping, or moving the part of the body of the subject.

An increase in demand for massage has led to an increase in demand for a massage apparatus or a massage device that provides an artificial massage function due to economic and time reasons. That is, with the increasing demand to relieve fatigue or stress by relaxing tightened muscles through massage, various time- and cost-effective massage apparatuses have been released.

In recent years, interest in the health of people has increased, and massage apparatuses have evolved from simply providing a massage function to becoming electronic devices that provide various additional functions and/or medical functions.

Meanwhile, an arm massage unit is provided in the massage apparatus, and a user can receive a massage by putting his or her arm into the arm massage unit.

The conventional arm massage unit rotates about a center of rotation, which is positionally fixed to a side surface portion of a body of the massage apparatus or positionally fixed to one side thereof, and does not have a separate space for placing the arm when the user does not use an arm massage function, resulting in reduced convenience.

In addition, since one side of the arm massage unit is positionally fixed at the center of rotation, deformation in the position of the arm massage unit results in a relative increase in the height of the other side of the arm massage unit, which is opposite to the one side, causing the user's arm to be positioned in a somewhat inconvenient posture.

Accordingly, there is a need to develop a massage apparatus capable of adjusting the position of an arm massage unit so that a user can place his or her arm on the arm massage unit when not using an arm massage function and rest the arm on the arm massage unit in a comfortable posture when using the arm massage function.

### SUMMARY

The present disclosure is directed to providing a massage apparatus that ensures that the arm of a user using the massage apparatus is in an ergonomically comfortable position by allowing a position adjustment unit to change the height and inclination of an arm massage unit and adjust the position of the arm massage unit.

However, the problems to be solved by the present disclosure are not limited to the above-described problems and include problems that may be easily understood by those skilled in the art to which the present disclosure pertains from the present specification and the accompanying drawings.

Additional aspects will be set forth in part in the description which follows and, in part, will be apparent from the description, or may be learned by practice of the presented embodiments of the disclosure.

In order to achieve the object described above, according to an embodiment of the present disclosure, there is provided a massage apparatus capable of adjusting the portion of an arm massage unit, the massage apparatus including a body massage unit configured to massage at least a part of a body of a user, the arm massage unit disposed on a side portion of the body massage unit and configured to massage an arm of the user, and a lifting and lowering unit disposed on a lower portion of the arm massage unit and configured to adjust a position of the arm massage unit.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a massage apparatus according to embodiments of the present disclosure;

FIG. 2 is a view for describing a frame unit according to embodiments of the present disclosure;

FIG. 3 is a view for describing components of the massage apparatus according to embodiments of the present disclosure;

FIG. 4 is a view illustrating a state in which a user's arm is placed on an arm massage unit;

FIG. 5 is a view illustrating a state in which the position of the arm massage unit of FIG. 4 is adjusted;

FIG. 6 is a perspective view illustrating a lifting and lowering unit according to an embodiment of the present disclosure;

FIG. 7 is a perspective view illustrating a state in which a lifting and lowering unit according to an embodiment of the present disclosure is unfolded;

FIG. 8 is a side view illustrating a state in which the lifting and lowering unit according to an embodiment of the present disclosure is unfolded;

FIG. 9 is an enlarged view of portion A of FIG. 7;

FIG. 10 is an enlarged view of a portion B of FIG. 7;

FIG. 11 is a perspective view illustrating a lifting and lowering unit according to another embodiment of the present disclosure;

FIG. 12 is a perspective view illustrating a state in which the lifting and lowering unit according to another embodiment of the present disclosure is unfolded;

FIG. 13 is an enlarged view of portion C of FIG. 11;

FIG. 14 is an enlarged view of portion D of FIG. 12; and

FIG. 15 is an enlarged view of portion E of FIG. 12.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Objectives, features, and advantages of the present disclosure described above will become more apparent through the following embodiments related to the accompanying drawings. The following specific structure or functional descriptions are exemplified only to describe embodiments according to the concept of the present disclosure, the embodiments according to the concept of the present disclosure may be implemented in various forms, and the present disclosure should not be construed as being limited to the embodiments described in the present specification or application.

Since the embodiments according to the concept of the present disclosure may be variously changed and have various forms, specific embodiments are intended to be illustrated in the drawings and to be described in detail in the present specification or application. However, it should be understood that this is not intended to limit the embodiments according to the concept of the present disclosure to a specific disclosure, and all changes, equivalents, and substitutes included in the spirit and scope of the present disclosure are included.

Terms such as “first” and/or “second” may be used to describe various components, but the components are not limited by the terms. The terms are used only to distinguish one component from other components. For example, without departing from the scope of rights according to the concept of the present disclosure, a first component may be called a second component, and similarly, a second component may be called a first component.

When it is described that one component is “connected to” or “electrically connected to” another component, it should be understood that the one component may be directly connected or electrically connected to another component or yet another component may be provided therebetween. On the other hand, when it is described that one component is “directly connected to” or “directly electrically connected to” another component, it should be understood that yet another component is not present therebetween. Other expressions used to describe the relationships between components, such as “between” and “directly between” or “adjacent” and “directly adjacent,” should be interpreted in the same manner.

Terms used in the present specification are used only to describe specific embodiments and are not intended to limit the present disclosure. Singular expressions include plural expressions unless clearly otherwise indicated in the context. It should be understood in the present specification that the terms “include” or “have” are intended to indicate that there are features, numbers, steps, operations, components, parts, or combinations thereof that are implemented and do not exclude in advance the possibility of the presence or addition of one or more other features, numbers, steps, operations, components, parts, or combinations thereof.

Unless otherwise defined, all terms used herein including technical or scientific terms have the same meanings as those commonly understood by those skilled in the art to which the present disclosure belongs. Terms defined in commonly used dictionaries should be interpreted as having the same meanings in the context of the related art and should not be interpreted with ideal or excessively formal meanings, unless explicitly defined in the present specification.

In the present specification, an actuator is a component that may provide a driving force. For example, examples of actuators may include a motor, a linear motor, an electronic motor, a direct current (DC) motor, an alternating current (AC) motor, a linear actuator, an electric actuator, and the like, but the present disclosure is not limited thereto.

In the specification, a binaural beat may mean audio information having a particular form capable of adjusting a brainwave.

In the specification, according to an embodiment, a massage apparatus may refer to a massage apparatus including a body massage unit and a leg massage unit. In addition, according to another embodiment, the body massage unit and the leg massage unit may exist as separate apparatuses (for example, a body massage apparatus and a leg massage apparatus), and the massage apparatus may refer to a body massage apparatus or a leg massage apparatus.

Hereinafter, embodiments of the present disclosure will be described in more detail with reference to the accompanying drawings.

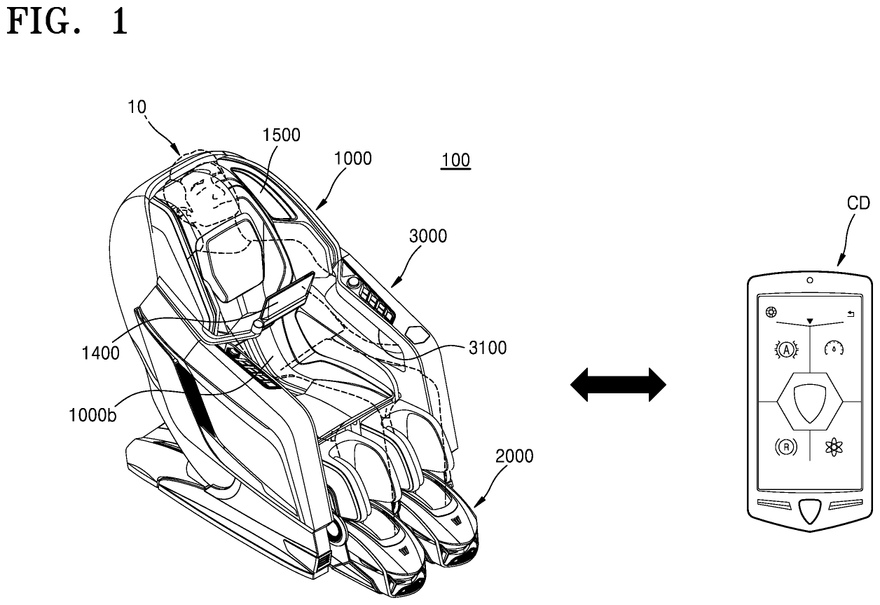

FIG. 1 is a view illustrating one embodiment of a massage apparatus 100 according to the present disclosure.

The massage apparatus 100 according to an embodiment of the present disclosure may include a body massage unit 1000 configured to form a region for accommodating at least a part of a user's body and massage the user's body and a leg massage unit 2000 configured to massage user's legs.

The body massage unit 1000 may provide massage to at least a part of the user's body. The body massage unit 1000 may include a massage module 1700 configured to perform a massage function on at least a part of the user's body, an audio output module 1500 configured to perform audio output of any form toward a user, a frame unit 1100 configured to form a framework of the body massage unit 1000, and a user input unit 1400 configured to receive any form of input from the user.

The above-described components included in the body massage unit 1000 are merely an exemplary embodiment, and the body massage unit 1000 may include various components in addition to the above-described components.

In addition, the shape and structure of the massage apparatus 100 shown in FIG. 1 are merely exemplary, and various types of the massage apparatus 100 may be included within the scope of the present disclosure without departing from the scope of the present disclosure which is defined by the claims.

The body massage unit 1000 may form a space having any shape for accommodating the user. The body massage unit 1000 may have a space having a shape corresponding to the shape of the user's body. For example, as shown in FIG. 1, the body massage unit 1000 may be implemented as a sitting type capable of accommodating the entire or a part of the user's body.

A part of the body massage unit 1000, which comes into contact with the ground, may include any material for increasing a frictional force or any member (for example, a skid-proof pad or the like) for increasing a frictional force and may include wheels to enhance mobility of the massage apparatus 100.

At least a part of the body massage unit 1000 may slidingly move. For example, when the body massage unit 1000 starts a massage, at least a part of the body massage unit 1000 may slidingly move forward. In addition, the body massage unit 1000 may be tilted backward. As a result, the body massage unit 1000 may provide massage while being tilted backward.

According to an embodiment of the present disclosure, the massage apparatus 100 may include at least one air cell. The air cell may be located at a shoulder part and a pelvic part of the user, an arm massage unit 3000, the leg massage unit 2000, and the like, but is not limited thereto, and may be disposed in various parts of the massage apparatus 100.

The massage apparatus 100 may include an air supply unit, and the air supply unit may inflate the air cell by supplying air to the air cell. The air supply unit may be located inside the body massage unit 1000 and may be located in the leg massage unit 2000. In addition, the air supply unit may be located outside the massage apparatus 100.

The leg massage unit 2000 may provide a leg massage to the user. For example, the leg massage unit 2000 may include a calf massage part configured to massage the calves of the user and/or a foot massage unit configured to massage the feet of the user.

The leg massage unit 2000 may be adjustable in length according to physical characteristics of the user. For example, when a tall user uses the massage apparatus 100, since the calves of the user are long, it is necessary to increase a length of the leg massage unit 2000. In addition, when a short user uses the massage apparatus 100, since the calves of the user are short, it is necessary to decrease the length of the leg massage unit 2000. Accordingly, the leg massage unit 2000 may provide the user with a leg massage customized according to the height of the user.

Referring to FIG. 1, the leg massage unit 2000 may include a plurality of leg massage unit bodies (not shown) to allow a user's left foot and right foot to enter, respectively, and the plurality of leg massage unit bodies may be independently driven.

The massage module 1700 may be provided inside the body massage unit 1000 to provide any form of dynamic stimulation to the user accommodated in the body massage unit 1000. The massage module 1700 may move along a frame unit 1100 provided inside the body massage unit 1000 shown in FIG. 1.

For example, rack gears 1112 may be provided in the frame unit 1100 of the body massage unit 1000, and the massage module 1700 may provide dynamic stimulation to various parts of the user's body while moving along the rack gear 1112. The massage module 1700 may include a ball massage unit or a roller massage unit, but the present disclosure is not limited thereto.

The frame unit 1100 forms a framework of an internal configuration of the body massage unit 1000, and may be implemented with a metal material, a plastic material, or the like. For example, the frame unit 1100 may be implemented with iron, an alloy, steel, or the like, but is not limited thereto, and may be implemented with various rigid materials.

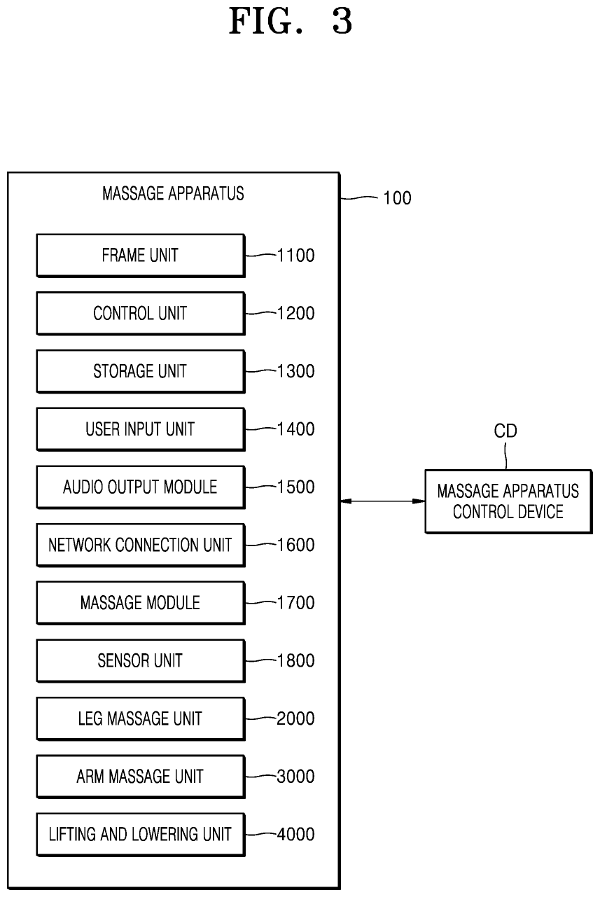

Referring to FIG. 3, according to an embodiment of the present disclosure, the massage apparatus 100 may include the audio output module 1500. The audio output module 1500 may be provided at various positions. For example, the audio output module 1500 may include a plurality of output units such as an upper audio output unit disposed on an upper end of a seat unit 1000b in contact with the user sitting on the massage apparatus 100, a front audio output unit attached to a front end of the arm massage unit 3000 located at each of left and right sides of the seat unit 1000b, and/or a rear audio output unit attached to a rear end of the arm massage unit 3000, but the present disclosure is not limited thereto.

In this case, the audio output module 1500 may provide a stereoscopic sound, such as a 5.1 channel sound, but the present disclosure is not limited thereto.

According to an embodiment of the present disclosure, the user may control the massage apparatus 100 by using a massage apparatus control device CD. The massage apparatus control device CD may be connected to the massage apparatus 100 through wired communication and/or wireless communication.

The massage apparatus control device CD may include a remote controller, a cellular phone, personal digital assistant (PDA), and the like, but is not limited thereto, and may include various electronic devices capable of being connected to the massage apparatus 100 through wired or wireless communication.

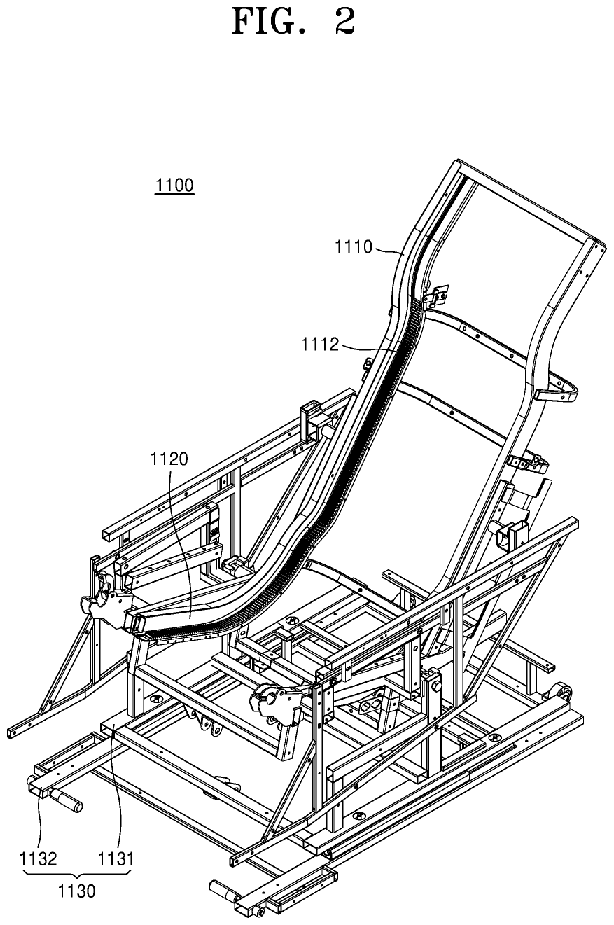

FIG. 2 is a view for describing the frame unit of FIG. 1, and FIG. 3 is a view for describing components of the massage apparatus according to an embodiment of the present disclosure.

According to an embodiment of the present disclosure, the massage apparatus 100 may include at least one of the frame unit 1100, a control unit 1200, a storage unit 1300, the user input unit 1400, the audio output module 1500, a network connection unit 1600, and the massage module 1700.

The frame unit 1100 may be a component that forms a framework of the body massage unit 1000.

According to an embodiment of the present disclosure, the frame unit 1100 may include a body frame (not shown) in which the massage module 1700 is provided, and a base frame 1130 configured to support the body frame.

The body frame may include a back frame 1110 configured to form a framework of a user's upper body accommodation part (not shown) and a seat frame 1120 configured to form a framework of the seat unit.

The rack gear 1112 may be provided on at least a part of the body frame. The rack gear 1112 is a member for guiding the movement of the body massage module in a vertical direction (based on FIG. 2), and may include a plurality of valley parts and a plurality of ridge parts.

According to an embodiment of the present disclosure, the rack gears 1112 may be provided to face each other on both sides of the body frame, specifically, the back frame 1110 and the seat frame 1120, and the body massage module may move along the rack gears 1112.

For example, the body massage module may include gears to be engaged with the rack gears 1112, and the body massage module may move upward or downward as the gears are rotated by an actuator provided in the body massage module.

The rack gear 1112 may be implemented with a metal material or a plastic material. For example, the rack gear 1112 may be implemented with iron, steel, an alloy, reinforced plastics, a melamine resin, a phenolic resin, and the like, but the present disclosure is not limited thereto.

The body frame may be implemented in various shapes. For example, the body frame may be divided, according to a shape, into an S frame, an L frame, an S&L frame, and a double S&L frame, but the present disclosure is not limited thereto.

The S frame refers to a frame of the body frame, which has a shape at least partially curved like the letter “S.” The L frame refers to a frame of the body frame, which has a shape at least partially bent like the letter “L,” the S&L frame refers to a frame which has both the shape curved like the letter “S” and the shape bent like the letter “L,” and the double S&L frame refers to a frame including a part bent like the letter “L” and two parts curved like the letter “S.”

The base frame 1130 refers to a part that supports the body frame of the frame unit 1100 and comes into contact with the ground. The base frame 1130 may include an upper base frame 1131 and a lower base frame 1132.

The upper base frame 1131 may support the body frame, and the lower base frame 1132 may come into contact with the ground. In addition, the upper base frame 1131 may be located to be in contact with the lower base frame 1132.

According to an embodiment of the present disclosure, the upper base frame 1131 may move along the lower base frame 1132. For example, the upper base frame 1131 may slidingly move forward or backward along the lower base frame 1132. In this case, the body frame may be connected to the upper base frame 1131 and may move according to the movement of the upper base frame 1131.

For example, when the upper base frame 1131 moves forward, the body frame may also be moved forward, and when the upper base frame 1131 moves backward, the body frame may also be moved backward. Accordingly, sliding movement of the body massage unit 1000 may be allowed.

The control unit 1200 may control operations of the massage apparatus 100. The control unit 1200 may be implemented as one processor, or may be implemented as a plurality of processors. When the control unit 1200 is implemented as a plurality of processors, at least some of the plurality of processors may be located at physically spaced distances from each other. In addition, the control unit 1200 is not limited thereto and may be implemented in various ways.

For example, the control unit 1200 may correspond to one or a plurality of processors. The processor may be implemented as an array of multiple logic gates or may be implemented as a combination of a general-purpose microprocessor and a memory in which a program executable in the microprocessor is stored. Further, it may be understood by those skilled in the art to which the present embodiment pertains that the control unit may be implemented in other types of hardware.

According to an embodiment of the present disclosure, the control unit 1200 may control operations of the massage apparatus 100.

For example, the massage apparatus 100 may include a plurality of actuators, and the massage apparatus 100 may control the operations of the massage apparatus 100 by controlling operations of the plurality of actuators. For example, the massage apparatus 100 may include at least one of an actuator for moving the massage module 1700, at least one actuator included in the massage module 1700, a back angle actuator, a leg angle actuator, a foot massage actuator, a leg length adjustment actuator, and a sliding actuator, and the control unit 1200 may control the operations of the massage apparatus 100 by controlling the above actuators.

The actuator for moving the massage module 1700 is an actuator that allows the massage module 1700 to move vertically, and the massage module 1700 may move along the rack gear 1112 by an operation of the actuator for moving the massage module.

The back angle actuator is an actuator that adjusts an angle of a part of the massage apparatus 100, which comes into contact with the back of the user, and a back angle of the massage apparatus 100 may be adjusted by an operation of the back angle actuator.

The leg angle actuator is an actuator that adjusts an angle of the leg massage unit 2000 of the massage apparatus 100, and an angle between the leg massage unit 2000 and the body massage unit 1000 may be adjusted by an operation of the leg angle actuator.

The foot massage actuator refers to an actuator that operates the foot massage module included in the leg massage unit 2000. The massage apparatus 100 may provide a foot massage to the user using the foot massage actuator.

The massage module 1700 may include at least one actuator, and the control unit 1200 may provide various massage operations by operating the at least one actuator. For example, the control unit 1200 may provide a beating massage, a kneading massage, and the like by operating the at least one actuator included in the massage module 1700, but is not limited thereto, and may provide various massage operations.

The leg length adjustment actuator refers to an actuator that adjusts a length of the leg massage unit 2000. For example, the control unit 1200 may use the leg length adjustment actuator to adjust the length of the leg massage unit 2000 according to the user, which ensures that the user receives a massage customized to his or her body shape.

The sliding actuator enables a sliding operation of the massage apparatus 100. For example, the horizontal upper base frame 1131 may be moved forward or backward by an operation of the sliding actuator, and as a result, the body frame connected to the horizontal upper base frame 1131 may also be moved forward or backward.

The storage unit 1300 may store various pieces of information related to the massage apparatus 100. For example, the storage unit 1300 may include massage control information, and may include personal authentication information, but the present disclosure is not limited thereto.

The storage unit 1300 may be implemented with a non-volatile storage medium capable of continuously storing any data. For example, the storage unit 1300 may include not only a disk, an optical disk, and a magneto-optical storage device, but also a storage device based on a flash memory and/or a battery-backup memory, but the present disclosure is not limited thereto.

In addition, the storage unit 1300 may include a memory. The memory is a main storage device like a random access memory (RAM) such as a dynamic RAM (DRAM), a static RAM (SRAM), and the like, which is directly accessed by a processor and may refer to a volatile storage device in which stored information is instantaneously erased when power is turned off, but the present disclosure is not limited thereto. Such a memory may be operated by the control unit 1200.

The user input unit 1400 may receive a command related to controlling the operation of the massage apparatus 100 from the user, and the user input unit 1400 may be implemented in various forms. For example, the user input unit 1400 may be provided in the body massage unit 1000, and may be provided in the leg massage unit 2000 and the arm massage unit 3000, but the present disclosure is not limited thereto.

The massage apparatus 100 may obtain various commands from the user through the user input unit 1400. For example, the massage apparatus 100 may receive any command related to selection of the massage module, selection of a massage mode, selection of massage intensity, selection of massage time, selection of a massage region, selection of a position and an operation of the body massage unit 1000, selection of power On-Off of the massage apparatus 100 on and off, selection with respect to whether a warming function is performed, selection related to reproducing a sound source, and the like, but the present disclosure is not limited thereto.

In an optional embodiment, the user input unit 1400 may include buttons in the form of a hot key and/or selection buttons for executing direction selection, cancellation, and input according to preset user setting functions or self-preset functions, or the like.

The user input unit 1400 may be implemented with a key pad, a dome switch, a (static sensitive/capacitive) touch pad, a jog wheel, a jog switch, and the like, but the present disclosure is not limited thereto. In addition, the user input unit 1400 may obtain a command through an utterance of the user on the basis of voice recognition technology.

According to an embodiment of the present disclosure, the user input unit 1400 may include a display for displaying an operation state of the massage apparatus 100, a current state of the user, or the like. In this case, the display may include at least one of a liquid crystal display (LCD), a thin-film transistor LCD (TFT LCD), an organic light-emitting diode (OLED), a flexible display, and a three-dimensional (3D) display, but the present disclosure is not limited thereto.

The audio output module 1500 can provide any form of audio output to the user. For example, the audio output module 1500 may provide brain stimulation to the user by outputting a sound source and/or a binaural beat, which are optimized for a massage pattern provided by the massage apparatus 100, to the user. The audio output module 1500 may output an acoustic signal received through a network (not shown) or stored in an internal/external storage medium (not shown).

For example, the audio output module 1500 may output a sound source under control of a user terminal through a network connection (for example, Bluetooth connection and the like) with the user terminal. In addition, the audio output module 1500 may output an arbitrary formed acoustic signal generated in relation to the operation of the massage apparatus 100.

The massage apparatus 100 according to an embodiment of the present disclosure may include the network connection unit 1600. The network connection unit 1600 may perform communication with the modules inside the massage apparatus 100, an external massage apparatus 100, and/or the user terminal through any form of network.

The network connection unit 1600 may include a wired/wireless connection module for network connection. As a wireless connection technology, for example, wireless local area network (WLAN), Wi-Fi, wireless broadband (Wibro), world interoperability for microwave access (WiMAX), high speed downlink packet access (HSDPA), and the like may be used.

As a wired connection technology, for example, x digital subscriber line (xDSL), fibers to the home (FTTH), power line communication (PLC), and the like may be used. In addition, the network connection unit 1600 may include a short-range communication module to transmit and receive data to/from any device/terminal located in a short distance. For example, as a short-range communication technology, Bluetooth, radio frequency identification (RFID), infrared data association (IrDA), ultra wideband (UWB), ZigBee, and the like may be used, but the present disclosure is not limited thereto.

As described above, the massage apparatus 100 according to an embodiment of the present disclosure may include the massage module 1700. That is, the massage module 1700 is a component that provides dynamic stimulation to the user, and the massage module 1700 may move along the frame unit 1100.

The massage apparatus 100 according to an embodiment of the present disclosure may include the frame unit 1100. As described above with reference to FIGS. 1 to 3, the frame unit 1100 may provide a path through which the massage module 1700 may move.

The control unit 1200 may control the operation of the massage module 1700 to apply dynamic stimulation to the user, thereby providing a massage to the user.

The control unit 1200 may control the massage module 1700 to move in directions such as an X-axis, a Y-axis, and a Z-axis. The control unit 1200 may control the massage ball to move forward or backward on the X-axis, the Y-axis, and the Z-axis. Alternatively, the control unit 1200 may control the massage ball to rotate around the X-axis, the Y-axis, and the Z-axis.

The massage apparatus 100 according to an embodiment of the present disclosure may include a sensor unit 1800. Here, the sensor unit 1800 may include at least one sensor. For example, the sensor unit 1800 may include a touch sensor, a pressure sensor, an infrared sensor, a light-emitting diode (LED) sensor, a photo sensor, a Hall sensor, an electrostatic sensor, and the like, but the present disclosure is not limited thereto.

The sensor unit 1800 may be used to obtain various pieces of information. For example, the sensor unit 1800 may be used to recognize the user. That is, information on whether the user sits or not, the body shape of the user, whether the user's body is abnormal, or the like may be obtained. In another example, the sensor unit 1800 may be used for obtaining biometric information. That is, fingerprint information, face information, voice information, iris information, weight information, electrocardiogram information, body composition information, and the like may be obtained, but the present disclosure is not limited thereto, and various pieces of biometric information may be obtained.

In an optional embodiment, the massage apparatus 100 may detect a contact area and/or a contact position with the user through the sensor unit 1800.

In addition, the massage apparatus 100 may obtain shoulder position information of the user through the sensor unit 1800.

In addition, the massage apparatus 100 may provide a customized massage based on the obtained information. For example, when the massage apparatus 100 provides a shoulder massage, the massage apparatus 100 may recognize the shoulder position of the user on the basis of the information obtained through the sensor unit 1800 and provide the shoulder massage to the user according to the recognition result.

The leg massage unit 2000 may be a component for massaging the user's legs. A leg accommodation space in which the user's legs are accommodated may be formed in the leg massage unit 2000. Referring to FIG. 1, the leg massage unit 2000 may include a plurality of leg massage unit bodies, and the plurality of leg massage unit bodies may be independently driven by receiving electrical signals from the control unit 1200.

The leg massage unit 2000 may include at least one of an air cell, a calf massage module (not shown), and a foot massage unit (not shown).

The air cell may be a component for fixing at least a part of the user's body. The air cell included in the leg massage unit 2000 may be a component that receives air from a separately provided air supply unit and inflates to fix at least a part of the user's body.

The calf massage module (not shown) may be a component to massage a calf part of the accommodated leg of the user. Here, the calf massage module 1700 may include the ball massage unit or the roller massage unit as described above, but the present disclosure is not limited thereto.

The foot massage unit (not shown) may be a component to massage a user's foot. The foot massage unit may include the foot massage module for massaging the user's foot. Here, the foot massage module may include the ball massage unit or the roller massage unit, but the present disclosure is not limited thereto.

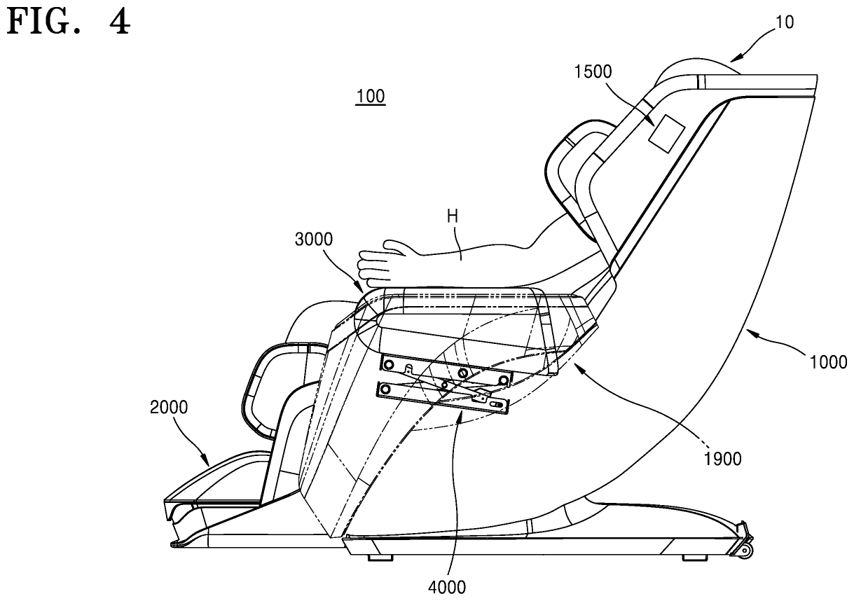

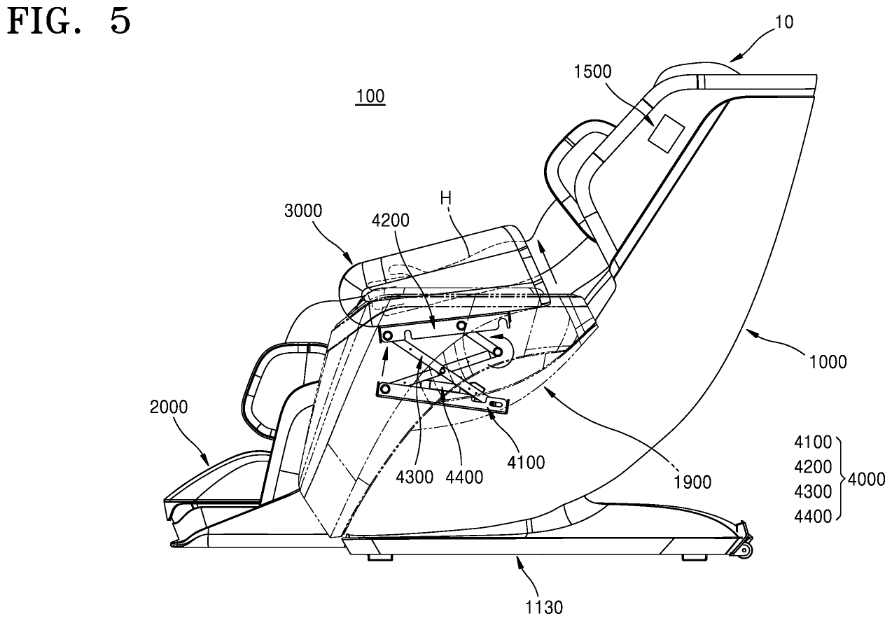

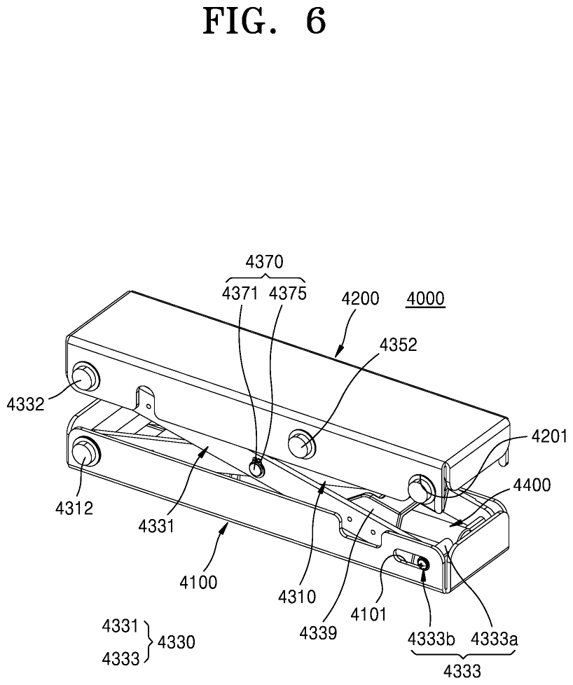

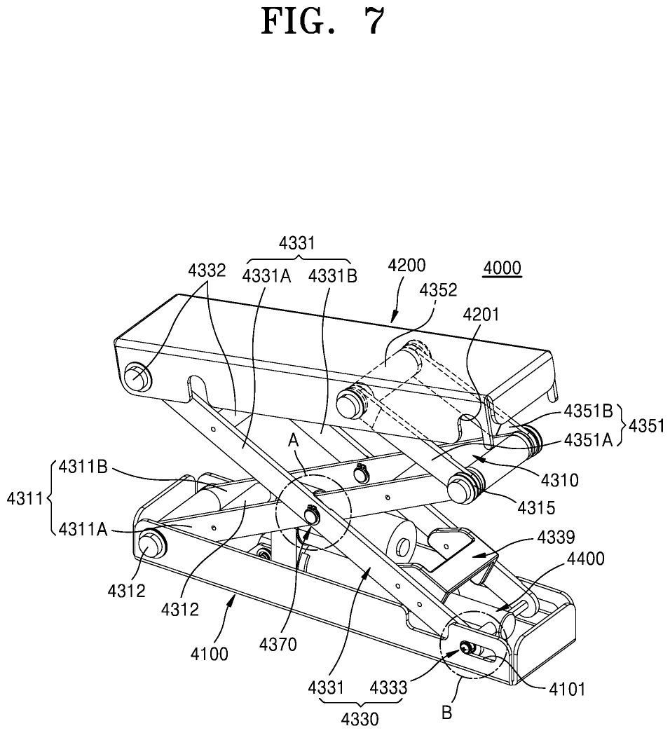

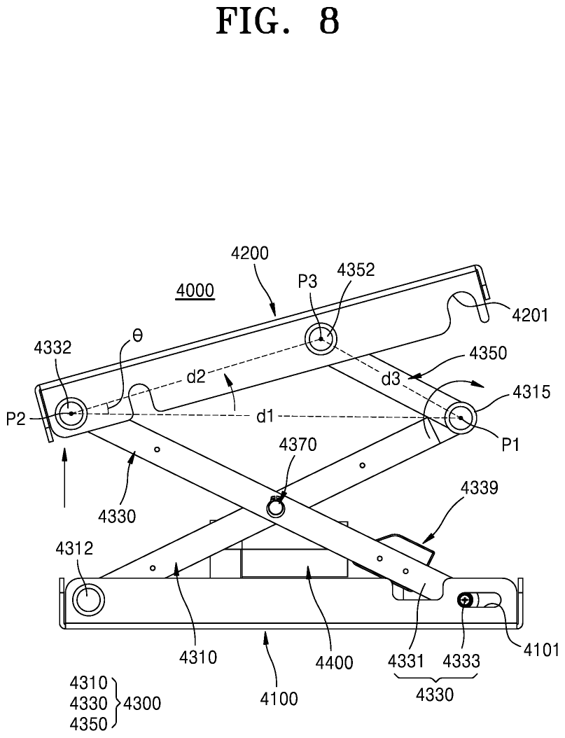

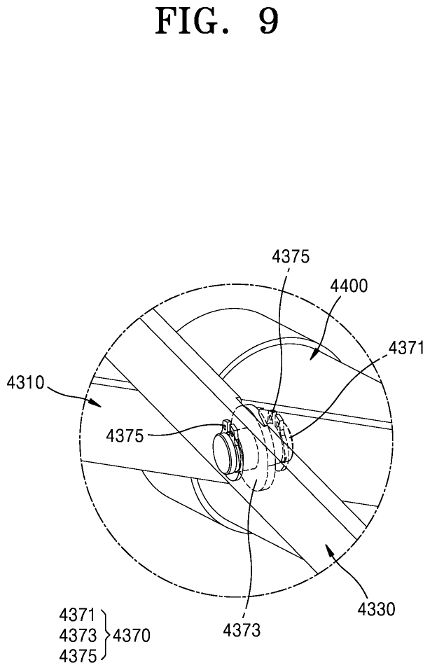

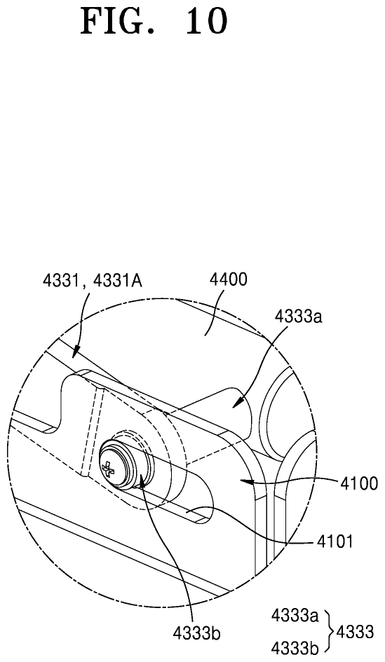

FIG. 4 is a view illustrating a state in which a user's arm is placed on the arm massage unit. FIG. 5 is a view illustrating a state in which the position of the arm massage unit of FIG. 4 is adjusted. FIG. 6 is a perspective view illustrating a lifting and lowering unit according to an embodiment of the present disclosure. FIG. 7 is a perspective view illustrating a state in which the lifting and lowering unit according to an embodiment of the present disclosure is unfolded. FIG. 8 is a side view illustrating a state in which the lifting and lowering unit according to an embodiment of the present disclosure is unfolded. FIG. 9 is an enlarged view of portion A of FIG. 7. FIG. 10 is an enlarged view of portion B of FIG. 7.

Referring now to FIGS. 4 and 5, illustrated is a side view of a massage apparatus (hereinafter referred to as “massage apparatus 100”) capable of adjusting the position of an arm massage unit 3000 according to an embodiment of the present disclosure, and a body massage unit 1000 may include a side accommodation unit 1900. The side accommodation unit 1900 is provided on a side surface of the body massage unit 1000, and may be provided on each of both sides of the body massage unit 1000 based on the front of the body massage unit 1000 on which a user can sit.

The arm massage unit 3000 may be accommodated inside the side accommodation unit 1900, and the position of the arm massage unit 3000 may be adjusted by a lifting and lowering unit 4000 to be described later.

Referring to FIG. 4, when the user does not use the arm massage unit 3000, the arm massage unit 3000 may be located inside the side accommodation unit 1900, and a resting unit 3100 on which the user's arm is rested may not be exposed to the outside, and when the position of the arm massage unit 3000 is adjusted by the lifting and lowering unit 4000, the resting unit 3100 may be exposed to the outside.

Accordingly, when the user does not use the arm massage unit 3000, the user may comfortably place an arm H thereof on an upper surface (based on FIG. 4) of the arm massage unit 3000. The upper surface of the arm massage unit 3000 may be formed as a flat surface so that the arm H of the user may be stably placed thereon.

Referring to FIGS. 4 to 8, the lifting and lowering unit 4000 according to an embodiment of the present disclosure is installed inside the body massage unit 1000, and may be disposed below the arm massage unit 3000 and may adjust the position of the arm massage unit 3000.

The lifting and lowering unit 4000 according to an embodiment of the present disclosure may move the arm massage unit 3000 in at least one of upward and downward directions of the arm massage unit 3000.

The lifting and lowering unit 4000 may be located inside the side accommodation unit 1900 provided on the side surface of the body massage unit 1000, and may be provided on each of both sides of the body massage unit 1000 based on the front of the body massage unit 1000 on which the user can sit. The lifting and lowering unit 4000 may be directly or indirectly coupled to the arm massage unit 3000, and as the lifting and lowering unit 4000 is driven, the position of the arm massage unit 3000 connected to the lifting and lowering unit 4000 may be adjusted.

Referring to FIGS. 4 and 5, the lifting and lowering unit 4000 and the arm massage unit 3000 according to an embodiment of the present disclosure are directly coupled to each other, but the present disclosure is not limited thereto, and various modified embodiments are possible, such as a bracket for connection may be disposed between the lifting and lowering unit 4000 and the arm massage unit 3000.

Referring to FIGS. 4 and 5, the lifting and lowering unit 4000 may be disposed in at least a part of the entire lower region of the arm massage unit 3000.

Specifically, the lifting and lowering unit 4000 may be disposed in a lower region of the arm massage unit 3000 between one end (a left end portion based on FIG. 4) and the other end (a right end portion based on FIG. 4) of the arm massage unit 3000.

Referring to FIGS. 6 to 8, the lifting and lowering unit 4000 according to an embodiment of the present disclosure may include a first base 4100, a second base 4200, a position adjustment unit 4300, and a driving unit 4400.

The first base 4100 according to an embodiment of the present disclosure is disposed inside the body massage unit 1000, and specifically, may be positionally fixed to the frame unit 1100 and disposed inside the side accommodation unit 1900.

Since the first base 4100 is positionally fixed to the frame unit 1100, the position of the arm massage unit 3000 may be adjusted while the second base 4200, which will be described later, is moved relative to the first base 4100. The first base 4100 may be formed of a metal or a non-metal material.

The driving unit 4400 to be described later is disposed on the first base 4100, and as the driving unit 4400 transmits power to the position adjustment unit 4300, the first base 4100 and the second base 4200, which are disposed to face each other, are changed in position by moving relative to each other, which allows the position of the arm massage unit 3000, which is connected to the second base 4200, to be adjusted.

The specific configuration of the first base 4100 will be described in detail when describing the position adjustment unit 4300, which will be provided later.

Referring to FIGS. 6 to 8, the second base 4200 according to an embodiment of the present disclosure is disposed to face the first base 4100, and the arm massage unit 3000 may be coupled to the second base 4200. That is, the arm massage unit 3000 may be disposed on the other side (upper side based on FIG. 6) of the second base 4200, which is opposite to one side (lower side based on FIG. 6) of the second base 4200 facing the first base 4100.

The second base 4200 and the arm massage unit 3000 may be fixed in position while being coupled to each other. In other words, since the relative position between the arm massage unit 3000 and the second base 4200 is fixed, as the second base 4200 is moved relative to the first base 4100, the position of the arm massage unit 3000 may be adjusted and changed.

That is, when a distance between the first base 4100 and the second base 4200 is relatively small, the arm massage unit 3000 may be disposed inside the side accommodation unit 1900 as shown in FIG. 4, and when the distance is relatively large, as the second base 4200 is spaced apart from the first base 4100, the arm massage unit 3000 may be exposed to the outside of the side accommodation unit 1900 as shown in FIG. 5.

Accordingly, the user may insert the arm H into the resting unit 3100 formed in the arm massage unit 3000.

Referring to FIGS. 4 and 5, the resting unit 3100 may be exposed to the outside of the massage apparatus 100 as the second base 4200 is moved relative to the first base 4100 by the position adjustment unit 4300.

The second base 4200 is movable relative to the first base 4100, which is positionally fixed to a preset region of the body massage unit 1000, by the position adjustment unit 4300 to be described later, and as the position adjustment unit 4300 is driven, an interval between the first base 4100 and the second base 4200 may be changed, causing the second base 4200 to be inclined at a preset angle relative to the first base 4100.

Referring to FIGS. 4 and 6, the second base 4200 according to an embodiment of the present disclosure may be disposed in parallel with the first base 4100 at a first position in which the arm massage unit 3000 is located inside the side accommodation unit 1900 provided in the body massage unit 1000.

However, as shown in FIGS. 7 and 8, as the position adjustment unit 4300 is driven, the second base 4200 may be spaced apart from the first base 4100 and may be disposed to be inclined at a preset angle with respect to the first base 4100 at a second position in which the position of the second base 4200 is changed by the position adjustment unit 4300.

The second base 4200 according to an embodiment of the present disclosure may be formed of the same material as the first base 4100. Specifically, the second base 4200 may be formed of a metal or a synthetic resin material.

As in the first base 4100, a detailed configuration of the second base 4200 according to an embodiment of the present disclosure will be described in detail when describing the position adjustment unit 4300.

Referring to FIGS. 6 to 8, the position adjustment unit 4300 according to an embodiment of the present disclosure is disposed between the first base 4100 and the second base 4200, and can adjust the position of the second base 4200 relative to the first base 4100.

The position adjustment unit 4300 according to an embodiment of the present disclosure may include a first link 4310, a second link 4330, a third link 4350, and a link connection part 4370.

Referring to FIGS. 6 to 9, the first link 4310 may be rotatably connected to the first base 4100.

Referring to FIGS. 6 to 8, the first link 4310 according to an embodiment of the present disclosure may be rotatably connected to the first base 4100 at one end portion thereof, and may be connected to the second link 4330 and the third link 4350 so as to be relatively rotatable.

Referring to FIGS. 7 and 8, the first link 4310 and the second link 4330 may be connected to each other with a longitudinal center thereof as a center of rotation, and may rotate relative to each other with the center as a central axis of rotation. Specifically, the first link 4310 may be connected to the second link 4330 in an “X” shape so as to be relatively rotatable.

As the first link 4310 and the second link 4330 rotate relative to each other about the center of rotation, the interval between the first base 4100 and the second base 4200 may be increased or decreased.

In addition, a height of an upper end portion (based on FIG. 8) of the first link 4310 and a height of an upper end portion (based on FIG. 8) of the second link 4330 may be changed.

Referring to FIG. 8, the heights of the upper end portions of the first link 4310 and the second link 4330 may be formed to be equal even when the first link 4310 and the second link 4330 rotate relative to each other.

In other words, as the first link 4310 and the second link 4330 rotate relative to each other, the height of the second base 4200 may be changed relative to the first base 4100 positionally fixed to a predetermined region inside the side accommodation unit 1900, and as the height of the second base 4200 is changed, a height of the arm massage unit 3000 coupled to the second base 4200 may be changed.

Referring to FIGS. 7 and 8, the first link 4310 according to an embodiment of the present disclosure may be rotatably connected to the third link 4350 at the other end portion thereof, which is opposite to one end portion of the first link 4310 connected to the first base 4100.

Specifically, as the third link 4350 is rotated in a clockwise or counterclockwise direction about the other end portion of the first link 4310, the position of an upper end portion (based on FIG. 8) of the third link 4350 may be changed.

As the position of the upper end portion of the third link 4350 is changed, the second base 4200 coupled to the second link 4330 and the third link 4350 may be disposed to be inclined at a preset angle relative to the first base 4100. This will be described in detail below.

Referring to FIGS. 6 to 8, the first link 4310 according to an embodiment of the present disclosure may include a first link body 4311, a support 4312, and a stopper 4315.

The first link body 4311 is formed in a bar shape, and may be provided in a pair and disposed to face each other. A pair of first link bodies 4311A and 4311B may be rotatably connected to the first base 4100 at one end portions thereof, and may be connected to each of the second link 4330 and the third link 4350 so as to be relatively rotatable.

The support 4312 connects the pair of first link bodies 4311A and 4311B facing each other, and by coupling both end portions of the support 4312 to the pair of first link bodies 4311A and 4311B, respectively, a distance between the pair of first link bodies 4311A and 4311B can be kept constant.

A plurality of supports 4312 may be provided, and may be disposed to be spaced apart from each other by a predetermined distance.

By connecting the pair of first link bodies 4311A and 4311B, which face each other, at a preset position by the support 4312, the pair of first link bodies 4311A and 4311B can be prevented from being twisted or moving relative to each other in a longitudinal direction.

The support 4312 according to an embodiment of the present disclosure may be disposed such that a longitudinal central axis thereof is shared with a central axis of rotation that allows the first link 4310 and the first base 4100 to rotate relative to each other.

The support 4312 may also be disposed such that a longitudinal central axis thereof is shared with a central axis of rotation that allows the first link 4310 and the third link 4350 to be described later to rotate relative to each other.

The support 4312 that rotatably connects the first link 4310 and the third link 4350 may have the same configuration as a support 4352 provided in the third link 4350 to be described later.

Referring to FIGS. 6 to 8, the stopper 4315 according to an embodiment of the present disclosure is provided on the other side of the first link 4310, which is opposite to one side of the first link 4310 connected to the first base 4100, and may be disposed in a region in which the first link 4310 and the third link 4350 are rotatably connected relative to each other.

Specifically, the stopper 4315 may be coupled to the support 4312, which shares a longitudinal central axis thereof with the central axis of rotation formed to allow the first link 4310 and the third link 4350 to rotate relative to each other.

Referring to FIG. 8, in one surface of the second base 4200 facing the stopper 4315 according to an embodiment of the present disclosure, a placing groove 4201 may be formed in the shape of a groove so as to be contactable with and placed over one surface (upper surface based on FIG. 8) of the stopper 4315 provided on the first link 4310.

When the second base 4200 and the arm massage unit 3000 coupled to the second base 4200 are moved toward the first base 4100 and reduced in height, the placing groove 4201, which is formed in one surface of the second base 4200 facing the first base 4100 with a predetermined depth toward an upper side (based on FIG. 8) of the second base 4200, may be placed over the stopper 4315 provided on the first link 4310.

Accordingly, the upper end portions (based on FIG. 8) of the first link 4310 and the second link 4330 and one end portion of the third link 4350 rotatably connected to the second base 4200 may be disposed on the same line, and the first base 4100 and the second base 4200 may be disposed in parallel.

Referring to FIGS. 6 to 8 and 10, the second link 4330 according to an embodiment of the present disclosure connects the first base 4100 and the second base 4200, and may be disposed to intersect with the first link 4310. Specifically, through the link connection part 4370 to be described later, the second link 4330 and the first link 4310 may have an “X” shape and may rotate relative to each other.

Referring to FIGS. 6 to 8 and 10, the other side of the second link 4330, which is opposite to one side of the second link 4330 rotatably connected to the second base 4200, is movable, specifically, linearly movable on the first base 4100.

Referring to FIGS. 7 and 8, the second link 4330 according to an embodiment of the present disclosure is connectable with the driving unit 4400 to be described later, and the other side of the second link 4330 is linearly movable on a rail 4101 formed in the first base 4100 by receiving power from the driving unit 4400.

Referring to FIGS. 6 to 8 and 10, the second link 4330 according to an embodiment of the present disclosure may include a second link body 4331, a support 4332, and a moving part 4333.

A pair of second link bodies 4331A and 4331B may be each formed in a bar shape similarly to the first link body 4311, and may be disposed to face each other. The pair of second link bodies 4331A and 4331B may be rotatably connected to the second base 4200 at one end portions thereof, and may be alternately disposed with the first link 4310, specifically, the pair of first link bodies 4311A and 4311B, respectively.

The other end portions of the pair of second link bodies 4331A and 4331B, which are opposite to the one end portions of the pair of second link bodies 4331A and 4331B rotatably connected to the second base 4200, may be connected to the moving part 4333, which will be described later, to be movable on the first base 4100.

The support 4332 connects the pair of second link bodies 4331A and 4331B facing each other, and by coupling both end portions of the support 4332 to the pair of second link bodies 4331A and 4331B, respectively, a distance between the pair of second link bodies 4331A and 4331B can be kept constant.

A plurality of supports 4332 may be provided, and may be disposed to be spaced apart from each other by a predetermined distance.

By connecting the pair of second link bodies 4331A and 4331B facing each other at a preset position by the support 4332, the pair of second link bodies 4331A and 4331B can be prevented from being twisted or moving relative to each other in a longitudinal direction.

The support 4332 according to an embodiment of the present disclosure may be disposed such that a longitudinal central axis thereof is shared with a central axis of rotation that allows the second link 4330 and the second base 4200 to rotate relative to each other.

In addition, referring to FIGS. 6 to 8, a support 4339 having a pair of contact surfaces, which are in surface contact with facing surfaces of the pair of second link bodies 4331A and 4331B, respectively, may be provided and may maintain an interval between the pair of second link bodies 4331A and 4331B.

Referring to FIGS. 6 to 8 and 10, the moving part 4333 according to an embodiment of the present disclosure is connected to the other side of the second link body 4331, which is opposite to one side of the second link body 4331 rotatably connected to the second base 4200, and may be connected to the driving unit 4400.

The second link 4330 is movable, specifically, linearly movable on the first base 4100 as the moving part 4333 according to an embodiment of the present disclosure receives power from the driving unit 4400.

Referring to FIGS. 7, 8, and 10, the moving part 4333 according to an embodiment of the present disclosure may include a moving shaft 4333a and a contact part 4333b. The moving shaft 4333a is connected to the driving unit 4400, and may receive power from the driving unit 4400.

Referring to FIGS. 7 and 10, in the present disclosure, the driving unit 4400 generates linear power in a cylindrical manner and transmits the linear power to the moving part 4333, specifically, the moving shaft 4333a, so that the moving part 4333 and one end portions of the pair of second link bodies 4331A and 4331B connected to the moving part 4333 may be moved linearly on the first base 4100.

However, the present disclosure is not limited thereto, and, within the technical spirit in which one end portion of the second link body 4331 is linearly movable on the rail 4101 formed in the first base 4100, various modified embodiments are possible, such as the moving shaft 4333a receiving power from the driving unit 4400 in various ways, such as by a pneumatic cylinder method, a hydraulic cylinder method, a rack-and-pinion method, a gear method, and the like.

Referring to FIG. 10, the contact part 4333b according to an embodiment of the present disclosure is connected to the moving shaft 4333a, and is contactable with the first base 4100, specifically, the rail 4101 formed in the first base 4100.

Referring to FIG. 10, the rail 4101 that provides a movement path for the contact part 4333b may be formed in the first base 4100 according to an embodiment of the present disclosure. In the present disclosure, the rail 4101 is formed in the shape of a hole. However, the present disclosure is not limited thereto, and within the technical spirit in which the contact part 4333b is contactable with an inner circumferential surface of the rail 4101 and is linearly movable on the rail 4101, various modified embodiments are possible, such as the rail 4101 being formed in the shape of a groove.

In an optional embodiment, the contact part 4333b coupled to the moving shaft 4333a may be formed by a roller method.

In an optional embodiment, the contact part 4333b coupled to the moving shaft 4333a may be formed of an elastically deformable material.

Referring to FIGS. 6, 8, and 10, as the moving part 4333 receiving power from the driving unit 4400 is moved linearly on the rail 4101 formed in the first base 4100, one end portion of the second link body 4331 connected to the moving part 4333 may be moved linearly on the first base 4100.

As the second link body 4331 is moved linearly on the first base 4100, the first link 4310 and the second link 4330 are rotated relative to each other about the link connection part 4370, which will be described later, serving as a center of rotation, and the upper end portions of the first link 4310 and the second link 4330 may be adjusted in height.

Referring to FIGS. 6 to 8, when the moving part 4333 is moved on the first base 4100 in a first direction (right to left direction based on FIG. 8), which is a direction toward one end portion of the first link 4310 connected to the first base 4100, the height of each of the upper end portions (based on FIG. 8) of the first link 4310 and the second link 4330 may be increased.

In other words, when the second base 4200 moves away from the first base 4100, which is positionally fixed to an inner side of the side accommodation unit 1900 provided in the body massage unit 1000, the position of the arm massage unit 3000, which is connected to the second base 4200, may be adjusted, so that the arm massage unit 3000 can be exposed to the outside of the side accommodation unit 1900.

Referring to FIGS. 6 to 8, the third link 4350 according to an embodiment of the present disclosure connects the first link 4310 and the second base 4200, and may include one end portion rotatably connected to the second base 4200 and the other end portion rotatably connected to the first link 4310.

Specifically, referring to FIGS. 6 and 8, the third link 4350 may be rotatably connected to the first link 4310 at a first point P1, and may be rotatably connected to the second base 4200 at a third point P3.

At this point, the second link 4330 may be rotatably connected to the second base 4200 at a second point P2.

Accordingly, a distance d2 between the second point P2 and the third point P3 and a distance d3 between the third point P3 and the first point P1 may be kept constant on the second base 4200.

Meanwhile, as the second link 4330, specifically, the moving part 4333 receiving power from the driving unit 4400, is moved on the rail 4101 formed in the first base 4100, the first link 4310 and the second link 4330 may be rotated relative to each other about the link connection part 4370 serving as a center of rotation, and a distance d1 between the first point P1 and the second point P2 may be changed.

Specifically, when the moving part 4333 is moved on the first base 4100 in the first direction (right to left direction based on FIG. 8), which is a direction toward one end portion of the first link 4310 connected to the first base 4100, the distance d1 between the first point P1 and the second point P2 may be reduced while the height of each of the upper end portions (based on FIG. 8) of the first link 4310 and the second link 4330 increases.

Accordingly, a height of a triangle including the first point P1, the second point P2, and the third point P3 is increased, the third link 4350 is rotated in the clockwise direction (based on FIG. 8) with respect to the first link 4310 about the first point P1 serving as a center of rotation, and the third point P3 is moved relatively upward (based on FIG. 8).

In other words, since the position of the second point P2 in a horizontal direction (a left and right direction based on FIG. 8) is fixed, the second base 4200 is rotated about the second point P2 serving as a center of rotation, and the second base 4200 may be disposed to be inclined such that the second base 4200 forms a preset angle with respect to the first base 4100, for example, 60°.

Accordingly, the position of the arm massage unit 3000 coupled to the second base 4200 can be adjusted to be inclined upward toward the user with respect to the horizontal direction (or the ground direction) of the first base 4100, and the user can put the arm H thereof into the resting unit 3100 formed in the arm massage unit 3000 in an ergonomically comfortable position and receive a massage.

Referring to FIGS. 7 and 8, the third link 4350 according to an embodiment of the present disclosure may include a third link body 4351 and the support 4352.

The third link body 4351 is formed in a bar shape, and may be provided in a pair and disposed to face each other. One end portions of a pair of third link bodies 4351A and 4351B may be rotatably connected to the second base 4200, and the other end portions thereof opposite to the one end portions may be connected to the first link 4310, specifically, to the pair of first link bodies 4311A and 4311B, respectively, so as to be relatively rotatable.

The support 4352 connects the pair of third link bodies 4351A and 4351B facing each other, and by coupling both end portions of the support 4352 to the pair of third link bodies 4351A and 4351B, respectively, a distance between the pair of third link bodies 4351A and 4351B can be kept constant.

A plurality of supports 4352 may be provided, and may be disposed to be spaced apart from each other by a predetermined distance.

By connecting the pair of third link bodies 4351A and 4351B facing each other at a preset position by the support 4352, the pair of third link bodies 4351A and 4351B can be prevented from being twisted or moving relative to each other in a longitudinal direction.

The support 4352 according to an embodiment of the present disclosure may be disposed such that a longitudinal central axis thereof is shared with a central axis of rotation that allows the third link 4350 and the second base 4200 to rotate relative to each other, and also allows the third link 4350 and the first link 4310 to rotate relative to each other.

Referring to FIGS. 6 to 9, the link connection part 4370 according to an embodiment of the present disclosure connects the first link 4310 and the second link 4330, and may alternately arrange the first link 4310 and the second link 4330.

The first link 4310 and the second link 4330 may rotate relative to each other about the link connection part 4370 serving as a center of rotation.

That is, the power generated by the driving unit 4400 is transmitted to the second link 4330, specifically, to the moving part 4333, and as the moving part 4333 is moved in the first direction (right to left direction based on FIG. 8) on the rail 4101 formed in the first base 4100, the first link 4310 and the second link 4330 may be rotated about the link connection part 4370 serving as a center of rotation.

As the first link 4310 and the second link 4330 rotate relative to each other, the position of the second base 4200 is changed relative to the positionally fixed first base 4100, and specifically, the second base 4200 is moved in a direction away from the first base 4100.

Referring to FIG. 8, as the height of the second base 4200 is relatively increased, the distance d1 between the first point P1 and the second point P2 is relatively reduced.

Accordingly, the height of the triangle including the first point P1, the second point P2, and the third point P3 is increased, the third link 4350 is rotated in the clockwise direction (based on FIG. 8) with respect to the first link 4310 about the first point P1 serving as a center of rotation, and the third point P3 is moved relatively upward (based on FIG. 8).

In other words, since the position of the second point P2 in the horizontal direction (the left and right direction based on FIG. 8) is fixed, the second base 4200 is rotated about the second point P2 serving as a center of rotation, and the second base 4200 may be disposed to be inclined such that the second base 4200 forms a preset angle with respect to the first base 4100, for example, 60°.

Referring to FIG. 9, the link connection part 4370 according to an embodiment of the present disclosure may include a link connection shaft 4371, an interval maintaining part 4373, and a fixing part 4375. The link connection shaft 4371 connects the first link 4310 and the second link 4330, and may form a central axis of rotation of the first link 4310 and the second link 4330.

Referring to FIG. 9, the interval maintaining part 4373 is connected to the link connection shaft 4371, and may be disposed between the first link 4310 and the second link 4330.

Since the interval maintaining part 4373 is disposed between the first link 4310 and the second link 4330, the first link 4310 and the second link 4330 may be disposed to be spaced apart from each other by a thickness of the interval maintaining part 4373, and thus, friction due to contact between the first link 4310 and the second link 4330 can be prevented.

Referring to FIG. 9, the fixing part 4375 is coupled to the link connection shaft 4371, and may be provided in plural.

The plurality of fixing parts 4375 may be disposed an outer side of each of the first link 4310, specifically, the first link body 4311, and the second link 4330, specifically, the second link body 4331, and may be fixed in position.

Due to this, the first link 4310 and the second link 4330 can be prevented from deviating in an outward direction with respect to the central axis of relative rotation.

The fixing part 4375 may be formed in a ring shape and may be formed of a metal or plastic material. In an optional embodiment, the fixing part 4375 may be formed of an elastically deformable material.

Referring to FIGS. 6 to 8, the driving unit 4400 according to an embodiment of the present disclosure transmits power to the position adjustment unit 4300, and specifically, the driving unit 4400 may be connected to the second link 4330 and transmit the power to the second link 4330.

The driving unit 4400 according to an embodiment of the present disclosure may be installed on the first base 4100.

The driving unit 4400 according to an embodiment of the present disclosure is disposed between the first base 4100 and the second base 4200, but various modified embodiments are possible, such as being disposed on the other side (lower side based on FIG. 8) of the first base 4100, which is opposite to one side (upper side based on FIG. 8) of the first base 4100 facing the second base 4200.

The driving unit 4400 may generate power by a hydraulic or pneumatic cylinder method. The driving unit 4400 may generate linear power and transmit the linear power to the second link 4330.

Referring to FIGS. 7 and 8, as the driving unit 4400 according to an embodiment of the present disclosure generates linear power in a predetermined direction (left and right direction based on of FIG. 8), the second link 4330 may linearly reciprocate.

The driving unit 4400 is connected to the second link 4330, specifically, to the moving part 4333, the linear power generated by the driving unit 4400 is transmitted to the moving part 4333, and the position of the second link body 4331 may be adjusted as the moving part 4333 is moved on the rail 4101 formed in the first base 4100.

Referring to FIGS. 6 to 8, when the moving part 4333 is moved on the first base 4100 in the first direction (right to left direction based on FIG. 8), which is a direction toward one end portion of the first link 4310 connected to the first base 4100, the first link 4310 and the second link 4330 are rotated relative to each other about the link connection part 4370 serving as a center of rotation, and the height of the upper end portion (based on FIG. 8) of each of the first link 4310 and the second link 4330 may be increased.

In other words, when the second base 4200 moves away from the first base 4100, which is positionally fixed to an inner side of the side accommodation unit 1900 provided in the body massage unit 1000, the position of the arm massage unit 3000, which is connected to the second base 4200, may be adjusted, so that the arm massage unit 3000 can be exposed to the outside of the side accommodation unit 1900.

On the contrary, when the moving part 4333, which has received power from the driving unit 4400, is moved in a second direction (left to right direction based on FIG. 8), which is a direction away from one end portion of the first link 4310 connected to the first base 4100, the first link 4310 and the second link 4330 are rotated relative to each other about the link connection part 4370 serving as a center of rotation, and the height of the upper end portion (based on FIG. 8) of each of the first link 4310 and the second link 4330 may be reduced.

In other words, when the second base 4200 moves closer to the first base 4100, which is positionally fixed to the inner side of the side accommodation unit 1900 provided in the body massage unit 1000, the position of the arm massage unit 3000, which is connected to the second base 4200, may be adjusted, so that the arm massage unit 3000 can be accommodated inside the side accommodation unit 1900.

With regard to the specific configuration of the lifting and lowering unit 4000 in the massage apparatus 100 according to an embodiment of the present disclosure, by adjusting the position of the second base 4200 relative to the first base 4100 through the position adjustment unit 4300, the position of the arm massage unit 3000 coupled to the second base 4200 can be adjusted.

Specifically, as the interval between the first base 4100 and the second base 4200 is changed by the position adjustment unit 4300, the second base 4200 and the arm massage unit 3000 coupled to the second base 4200 can be disposed to be inclined with respect to the first base 4100 by a preset angle.

That is, as not only the height of the arm massage unit 3000 is adjusted, but also the inclination along with the height of the arm massage unit 3000 is adjusted, the arm H of the user using the massage apparatus 100 can have an ergonomically comfortable position.

Hereinafter, the configuration, operation principle, and effect of a massage apparatus capable of adjusting the position of an arm massage unit according to another embodiment of the present disclosure will be described.

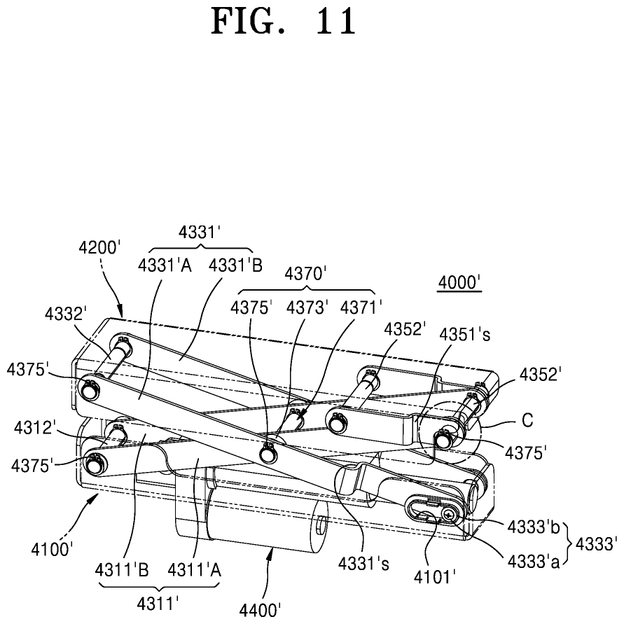

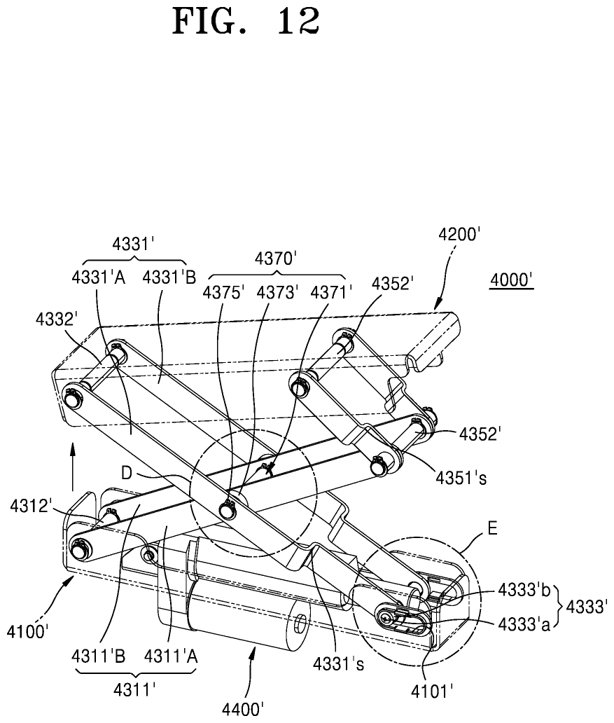

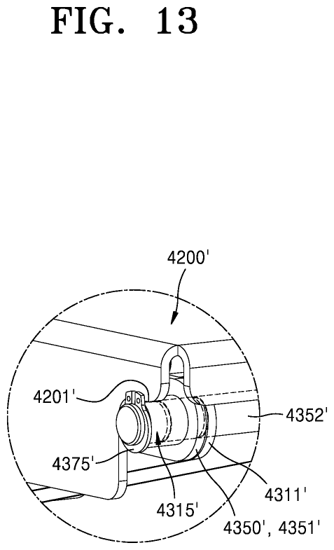

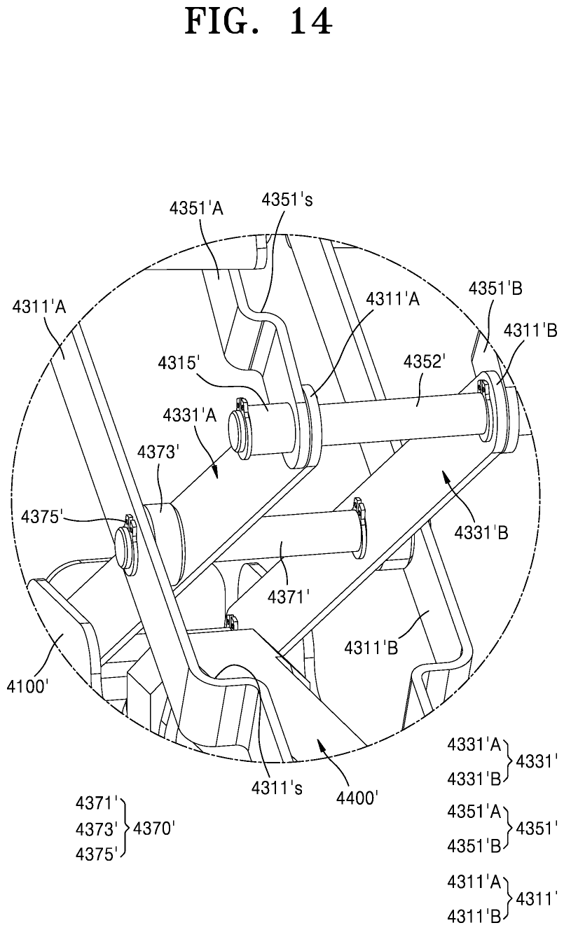

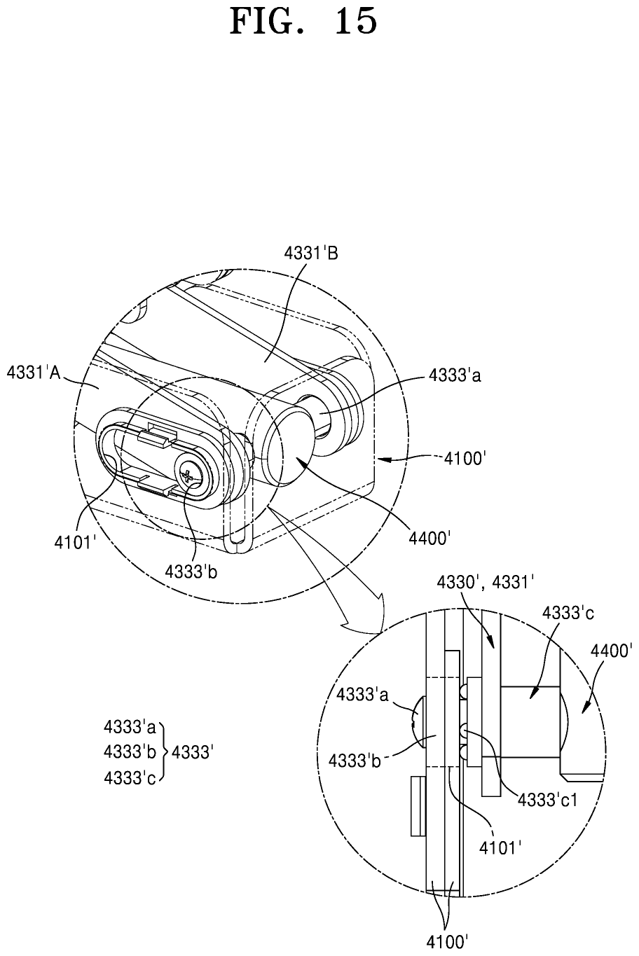

FIG. 11 is a perspective view illustrating a lifting and lowering unit according to another embodiment of the present disclosure. FIG. 12 is a perspective view illustrating a state in which the lifting and lowering unit according to another embodiment of the present disclosure is unfolded. FIG. 13 is an enlarged view of portion C of FIG. 11. FIG. 14 is an enlarged view of portion D of FIG. 12. FIG. 15 is an enlarged view of portion E of FIG. 12.

Referring to FIGS. 11 to 15, a lifting and lowering unit 4000′ according to another embodiment of the present disclosure is installed in the body massage unit 1000, and specifically, the lifting and lowering unit 4000′ may be located inside the side accommodation unit 1900.

The lifting and lowering unit 4000′ may be directly or indirectly coupled to the arm massage unit 3000, and as the lifting and lowering unit 4000′ is driven, the position of the arm massage unit 3000 connected to the lifting and lowering unit 4000′ may be adjusted.

Referring to FIGS. 11 to 15, the lifting and lowering unit 4000′ according to another embodiment of the present disclosure may include a first base 4100′, a second base 4200′, a position adjustment unit 4300′, and a driving unit 4400′.

The first base 4100′ is disposed inside the body massage unit 1000, and specifically, may be positionally fixed to the frame unit 1100 and disposed inside the side accommodation unit 1900.

Since the first base 4100′ is positionally fixed to the frame unit 1100, the position of the arm massage unit 3000 may be adjusted while the second base 4200′ is moved relative to the first base 4100′.

The driving unit 4400′ is disposed on the first base 4100′, and as the driving unit 4400′ transmits power to the position adjustment unit 4300′, the first base 4100′ and the second base 4200′, which are disposed to face each other, are changed in position by moving relative to each other, which allows the position of the arm massage unit 3000, which is connected to the second base 4200′, to be adjusted.

Referring to FIGS. 11 to 13, the second base 4200′ is disposed to face the first base 4100′, and the arm massage unit 3000 may be coupled to the second base 4200′.

Although not shown in the drawings, as in the second base 4200 according to an embodiment of the present disclosure, the arm massage unit 3000 may be disposed on the other side (upper side based on FIG. 11) of the second base 4200′, which is opposite to one side (lower side based on FIG. 11) of the second base 4200 facing the first base 4100′.

The second base 4200′ and the arm massage unit 3000 may be fixed in position while being coupled to each other, and thus, as the second base 4200′ is moved relative to the first base 4100′, the position of the arm massage unit 3000 may be changed.

That is, when a distance between the first base 4100′ and the second base 4200′ is relatively small, the arm massage unit 3000 may be disposed inside the side accommodation unit 1900, and when the distance is relatively large, as the second base 4200′ is spaced apart from the first base 4100′, the arm massage unit 3000 may be exposed to the outside of the side accommodation unit 1900.

Accordingly, the user may insert the arm H of the user into the resting unit 3100 formed in the arm massage unit 3000.

The second base 4200′ is movable relative to the first base 4100′, which is positionally fixed to a preset region of the body massage unit 1000, by the position adjustment unit 4300′, and as the position adjustment unit 4300′ is driven, an interval between the first base 4100′ and the second base 4200′ may be changed, causing the second base 4200′ to be inclined at a preset angle relative to the first base 4100′.

Referring to FIG. 11, the second base 4200′ may be disposed in parallel with the first base 4100′ at a first position in which the arm massage unit 3000 is disposed inside the side accommodation unit 1900 provided in the body massage unit 1000.

However, as shown in FIG. 12, as the position adjustment unit 4300′ is driven, the second base 4200′ may be spaced apart from the first base 4100′ and may be disposed to be inclined at a preset angle with respect to the first base 4100′ at a second position in which the position of the second base 4200′ is changed by the position adjustment unit 4300′.

Referring to FIGS. 11 to 15, the position adjustment unit 4300′ is disposed between the first base 4100′ and the second base 4200′, and can adjust the position of the second base 4200′ relative to the positionally fixed first base 4100′.

Referring to FIGS. 11 and 12, the position adjustment unit 4300′ may include a first link 4310′, a second link 4330′, a third link 4350′, and a link connection part 4370′. The first link 4310′ may be rotatably connected to the first base 4100′.

Referring to FIGS. 11 to 14, the first link 4310′ may be rotatably connected to the first base 4100′ at one end portion thereof, and may be connected to the second link 4330′ and the third link 4350′ so as to be relatively rotatable.

Referring to FIGS. 11 and 12, the first link 4310′ and the second link 4330′ may be connected to each other with a longitudinal center thereof as a center of rotation so as to be cross each other, and may rotate relative to each other with the center as a central axis of rotation. Specifically, the first link 4310′ may be connected to the second link 4330′ in an “X” shape so as to be relatively rotatable.

The first link 4310′ and the second link 4330′ are connected by the link connection part 4370′ so as to be relatively rotatable, and the relative rotation thereof can be performed using a longitudinal central axis of the link connection part 4370′ as a central axis of rotation.

Due to the relative rotation of the first link 4310′ and the second link 4330′, an interval between the first base 4100′ and the second base 4200′ may be increased or decreased, and a height of an upper end portion (based on FIG. 12) of the first link 4310′ and an upper end portion (based on FIG. 12) of the second link 4330′ may be changed.

Referring to FIG. 12, the heights of the upper end portions of the first link 4310′ and the second link 4330′ may be formed to be equal even when the first link 4310′ and the second link 4330′ rotate relative to each other.

In other words, as the first link 4310′ and the second link 4330′ rotate relative to each other, the height of the second base 4200′ may be changed relative to the first base 4100′ positionally fixed to a predetermined region inside the side accommodation unit 1900, and as the height of the second base 4200′ is changed, a height of the arm massage unit 3000 coupled to the second base 4200′ may be changed.

Referring to FIGS. 11 and 12, the first link 4310′ may be rotatably connected to the third link 4350′ at the other end portion thereof, which is opposite to one end portion of the first link 4310′ connected to the first base 4100′.

Specifically, as the third link is rotated in the clockwise or counterclockwise direction about the other end portion of the first link 4310′, the position of an upper end portion (based on FIG. 12) of the third link 4350′ may be changed.

As the position of the upper end portion of the third link 4350′ is changed, the second base 4200′ and the second link 4330′ coupled to the third link 4350′ may be disposed to be inclined with respect to the first base 4100′ by a preset angle, and the arm massage unit 3000 coupled to the second base 4200′ may be disposed to be inclined with respect to the first base 4100′.

Referring to FIGS. 11 to 13, the first link 4310′ may include first link bodies 4311′A and 4311′B (collectively referred to as “4311′”), a support 4312′, and a stopper 4315′. As compared to the first link 4310 according to an embodiment of the present disclosure, in the first link 4310′ according to another embodiment of the present disclosure, fixing parts 4375′ may be coupled to both end portions of the support 4312′, respectively.

Due to the fixing parts 4375′, the position of the support 4312′, which connects a pair of first link bodies 4311′A and 4311′B facing each other and forms a central axis of rotation of the first link bodies 4311′A and 4311′B, with respect to the first base 4100′ can be fixed.

The first link 4310′ according to another embodiment of the present disclosure has the same configuration as the first link 4310 according to an embodiment of the present disclosure except for the configuration of the support 4312′, and thus a detailed description will be omitted in the overlapping range.

Referring to FIGS. 11, 12, and 15, the second link 4330′ according to another embodiment of the present disclosure connects the first base 4100′ and the second base 4200′, and may be disposed to intersect with the first link 4310′. Specifically, through the link connection part 4370′, the second link 4330′ and the first link 4310′ may have an “X” shape and may rotate relative to each other.

Referring to FIGS. 11, 12, and 15, the other side of the second link 4330′, which is opposite to one side of the second link 4330′ rotatably connected to the second base 4200′, is movable, specifically, linearly movable on the first base 4100′.

The second link 4330′ is connectable to the driving unit 4400′, and the other side of the second link 4330′ is linearly movable on a rail 4101′ formed in the first base 4100′ by receiving power from the driving unit 4400′.

Referring to FIGS. 11, 12, 14, and 15, the second link 4330′ may include a second link body 4331′, a support 4332′, and a moving part 4333′.

In the second link body 4331′ according to another embodiment of the present disclosure, a bent part 4331′s having a predetermined radius of curvature and bending inwardly at a predetermined section may be formed. Accordingly, a width between a pair of second link bodies 4331′A and 4331′B facing each other is reduced, and a width of the first base 4100′ in which the second link body 4331′ is disposed may be reduced, thereby reducing the volume of the lifting and lowering unit 4000′.

In the second link 4330′ according to another embodiment of the present disclosure, the fixing parts 4375′ may be respectively coupled to both end portions of the support 4332′ that connects the pair of second link bodies 4331′A and 4331′B.

Due to the fixing parts 4375′, the position of the support 4332′, which connects the pair of second link bodies 4331′A and 4331′B facing each other and forms a central axis of rotation of the second link body 4331′, with respect to the second base 4200′ can be fixed.

Referring to FIGS. 11, 12, and 15, the moving part 4333′ according to another embodiment of the present disclosure is connected to the other side of the second link body 4331′, which is opposite to one side of the second link body 4331′ rotatably connected to the second base 4200′, and may be connected to the driving unit 4400′.

The moving part 4333′ is movable, specifically, linearly movable on the first base 4100′ by receiving power from the driving unit 4400′.

Referring to FIGS. 11, 12, and 15, the moving part 4333′ may include a moving shaft 4333′a and a contact part 4333′b. The moving shaft 4333′a is connected to the driving unit 4400′, and may receive power from the driving unit 4400′.

The driving unit 4400′ generates linear power in a cylindrical manner and transmits the linear power to the moving part 4333′, specifically, the moving shaft 4333′a, so that the moving part 4333′ and one end portions of the pair of second link bodies 4331′A and 4331′B connected to the moving part 4333′ may be moved linearly on the first base 4100′.

However, the present disclosure is not limited thereto, and, within the technical spirit in which one end portion of the second link body 4331′ is linearly movable on the rail 4101′ formed in the first base 4100′, various modified embodiments are possible, such as the moving shaft 4333′a receiving power from the driving unit 4400′ in various ways, such as by a pneumatic cylinder method, a hydraulic cylinder method, a rack-and-pinion method, a gear method, and the like.

Referring to FIG. 15, the contact part 4333′b according to another embodiment of the present disclosure is connected to the moving shaft 4333′a, and is contactable the rail 4101′ formed in the first base 4100′.

Referring to FIG. 15, the rail 4101′ that provides a movement path for the contact part 4333′b may be formed in the first base 4100′. In the present disclosure, the rail 4101′ is formed in the shape of a hole. However, the present disclosure is not limited thereto, and within the technical spirit in which the contact part 4333′b is contactable with an inner circumferential surface of the rail 4101′ and is linearly movable on the rail 4101′, various modified embodiments are possible, such as the rail 4101′ being formed in the shape of a groove.

In an optional embodiment, the contact part 4333′b coupled to the moving shaft 4333′a may be formed by a roller method.

In an optional embodiment, the contact part 4333′b coupled to the moving shaft 4333′a may be formed of an elastically deformable material.

In an optional embodiment, a guide groove (not shown) may be formed to allow the contact part 4333′b to be seated along the inner circumferential surface of the rail 4101′ formed in the first base 4100′.

Referring to FIGS. 11, 12, and 15, as the moving part 4333′ receiving power from the driving unit 4400′ is moved linearly on the rail 4101′ formed in the first base 4100′, one end portion of the second link body 4331′ connected to the moving part 4333′ may be moved linearly on the first base 4100′.

As one end portion of the second link body 4331′ connected to the moving part 4333′ is moved linearly on the first base 4100′, the first link 4310′ and the second link 4330′ are rotated relative to each other about the link connection part 4370′ serving as a center of rotation, and the height of the upper end portion of each of the first link 4310′ and the second link 4330′ may be adjusted.

Referring to FIGS. 11 and 12, when the moving part 4333′ is moved on the first base 4100′ in a first direction (right to left direction based on FIG. 12), which is a direction toward one end portion of the first link 4310′ connected to the first base 4100′, the height of each of the upper end portions (based on FIG. 12) of the first link 4310′ and the second link 4330′ may be increased.

In other words, when the second base 4200′ moves away from the first base 4100′, which is positionally fixed to an inner side of the side accommodation unit 1900 provided in the body massage unit 1000, the position of the arm massage unit 3000, which is connected to the second base 4200′, may be adjusted, so that the arm massage unit 3000 can be exposed to the outside of the side accommodation unit 1900.

Referring to FIG. 15, the moving part 4333′ according to another embodiment of the present disclosure may further include a friction reduction part 4333′c. The friction reduction part 4333′c may be couplable to the moving shaft 4333′a and may share a longitudinal central axis with the moving shaft 4333′a.

The friction reduction part 4333′c may have a hollow inside, and the moving shaft 4333′a may be inserted into and coupled to the friction reduction part 4333′c. The friction reduction part 4333′c is connectable to the second link body 4331′, prevents one surface of the first base 4100′, in which the rail 4101′ is formed, from coming in contact with the second link body 4331′, and ensures that the one surface of the second link body 4331′ and the first base 4100′ have a present interval.

Referring to FIG. 15, a protrusion 4333′cl may protrude from one surface of the friction reduction part 4333′c, which faces the first base 4100′, toward the first base 4100′. A plurality of protrusions 4333′c1 may be provided, and the plurality of protrusions 4333′cl may be disposed to be spaced apart from each other in a circumferential direction based on a longitudinal center of the friction reduction part 4333′c.

Accordingly, a contact area between the friction reduction part 4333′c and the first base 4100′ can be minimized, and damage caused by contact and friction therebetween can be prevented.

The second link 4330′ according to another embodiment of the present disclosure has the same configuration as the second link 4330 according to an embodiment of the present disclosure except for the configuration of the bent part 4331′s, the support 4332′, and the friction reduction part 4333′c, which are formed on the second link body 4331′, and thus a detailed description will be omitted in the overlapping range.

Referring to FIGS. 11, 12, and 14, the third link 4350′ connects the first link 4310′ and the second base 4200′, and may include one end portion rotatably connected to the second base 4200′ and the other end portion rotatably connected to the first link 4310′.

The third link 4350′ may include a third link body 4351′ and a support 4352′. The third link body 4351′ is formed in a bar shape, and may be provided in a pair and disposed to face each other. One end portions of a pair of third link bodies 4351′A and 4351′B may be rotatably connected to the second base 4200′, and the other end portions thereof opposite to the one end portions may be connected to the first link 4310′, specifically, the pair of first link bodies 4311′A and 4311′B, respectively, so as to be relatively rotatable.

In the third link body 4351′ according to another embodiment of the present disclosure, a bent part 4351′s having a predetermined radius of curvature and bending inwardly at a predetermined section may be formed. Accordingly, a width between a pair of third link bodies 4351′A and 4351′B facing each other is reduced, and a width of the second base 4200′ in which the third link body 4351′ is disposed may be reduced, thereby reducing the volume of the lifting and lowering unit 4000′.

In the third link 4350′ according to another embodiment of the present disclosure, the fixing parts 4375′ may be respectively coupled to both end portions of the support 4352′ that connects the pair of third link bodies 4351′A and 4351′B.

Due to the fixing parts 4375′, the position of the support 4352′, which connects the pair of third link bodies 4351′A and 4351′B facing each other and forms a central axis of rotation of the third link body 4351′, with respect to the second base 4200′ can be fixed.

The third link 4350′ according to another embodiment of the present disclosure has the same configuration and effect as the third link 4350 according to an embodiment of the present disclosure except that the bent part 4351′s is formed on the third link body 4351′ and the fixing parts 4375′ are coupled to both end portions of the support 4352′, and thus a detailed description will be omitted in the overlapping range.

Referring to FIGS. 11, 12, and 14, the link connection part 4370′ connects the first link 4310′ and the second link 4330′, and may alternately arrange the first link 4310′ and the second link 4330′.

The first link 4310′ and the second link 4330′ may be rotated relative to each other about the link connection part 4370′ serving as a center of rotation.

That is, the power generated by the driving unit 4400′ is transmitted to the second link 4330′, specifically, to the moving part 4333′, and as the moving part 4333′ is moved in the first direction (right to left direction based on FIG. 12) on the rail 4101′ formed in the first base 4100′, the first link 4310′ and the second link 4330′ may be rotated about the link connection part 4370′ serving as a center of rotation.

As the first link 4310′ and the second link 4330′ rotate relative to each other, the position of the second base 4200′ is changed relative to the positionally fixed first base 4100′, and specifically, the second base 4200′ is moved in a direction away from the first base 4100′.

Referring to FIG. 14, the link connection part 4370′ according to another embodiment of the present disclosure may include a link connection shaft 4371′, interval maintaining parts 4373′, and the fixing parts 4375′ The link connection shaft 4371′ connects the first link 4310′ and the second link 4330′, may form a central axis of rotation of the first link 4310′ and the second link 4330′.

Referring to FIG. 14, the link connection shaft 4371′ may pass through the pair of facing first link bodies 4311′A and 4311′B and the pair of facing second link bodies 4331′A and 4331′B to be coupled to the first link 4310′ and the second link 4330′.

Accordingly, an interval between the first link 4310′ and the second link 4330′ can be maintained, and a relative rotational center axis can be stably maintained.

The link connection part 4370′ according to another embodiment of the present disclosure has the same configuration, operation principle, and effect as the interval maintaining part 4373 and the fixing part 4375, which are specific components of the link connection part 4370 according to an embodiment of the present disclosure, except that the link connection shaft 4371′ is formed to extend and is coupled while passing through the pair of first link bodies 4311′ and the pair of second link bodies 4331′, and thus a detailed description will be omitted in the overlapping range.

Referring to FIGS. 11 and 12, the driving unit 4400′ according to another embodiment of the present disclosure transmits power to the position adjustment unit 4300′, and specifically, the driving unit 4400′ may be connected to the second link 4330′ and transmit the power to the second link 4330′.

The driving unit 4400′ according to another embodiment of the present disclosure may be installed on the first base 4100′. Unlike the driving unit 4400 according to an embodiment of the present disclosure disposed between the first base 4100 and the second base 4200, the driving unit 4400′ according to another embodiment of the present disclosure may be disposed to pass through the first base 4100′, and a partial region thereof may be located on the other side of the first base 4100′, which is opposite to one side of the first base 4100′ facing the second base 4200′.

The driving unit 4400′ may generate power by a hydraulic or pneumatic cylinder method. The driving unit 4400′ may generate linear power and transmit the linear power to the second link 4330′.

Referring to FIGS. 11, 12, and 15, as the driving unit 4400′ according to another embodiment of the present disclosure generates linear power in a predetermined direction (left and right direction based on of FIG. 11), the second link 4330′ may linearly reciprocate.

The driving unit 4400′ is connected to the second link 4330′, specifically, to the moving part 4333′, the linear power generated by the driving unit 4400′ is transmitted to the moving part 4333′, and the position of the second link body 4331′ may be adjusted as the moving part 4333′ is moved on the rail 4101′ formed in the first base 4100′.

Referring to FIG. 12, when the moving part 4333′ is moved on the first base 4100′ in the first direction (right to left direction based on FIG. 12), which is a direction toward one end portion of the first link 4310′ connected to the first base 4100′, the first link 4310′ and the second link 4330′ are rotated relative to each other about the link connection part 4370′ serving as a center of rotation, and the height of the upper end portion (based on FIG. 12) of each of the first link 4310′ and the second link 4330′ may be increased.

In other words, when the second base 4200′ moves away from the first base 4100′, which is positionally fixed to an inner side of the side accommodation unit 1900 provided in the body massage unit 1000, the position of the arm massage unit 3000, which is connected to the second base 4200′, may be adjusted, so that the arm massage unit 3000 can be exposed to the outside of the side accommodation unit 1900.

On the contrary, when the moving part 4333′, which has received power from the driving unit 4400′, is moved in a second direction (left to right direction based on FIG. 12), which is a direction away from one end portion of the first link 4310′ connected to the first base 4100′, the first link 4310′ and the second link 4330′ are rotated relative to each other about the link connection part 4370′ serving as a center of rotation, and the height of the upper end portion (based on FIG. 12) of each of the first link 4310′ and the second link 4330′ may be reduced.

In other words, when the second base 4200′ moves closer to the first base 4100′, which is positionally fixed to the inner side of the side accommodation unit 1900 provided in the body massage unit 1000, the position of the arm massage unit 3000, which is connected to the second base 4200′, may be adjusted, so that the arm massage unit 3000 can be accommodated inside the side accommodation unit 1900.

The lifting and lowering unit 4000′ provided in the massage apparatus according to another embodiment of the present disclosure is the same as the lifting and lowering unit 4000 according to an embodiment of the present disclosure in the remaining configuration, operating principle, and effect, except that the lifting and lowering unit 4000′ can reduce the volume occupied inside the side accommodation unit 1900 provided in the body massage unit 1000 by forming the bent parts 4331′s and 4351′s in the second link body 4331′ and the third link body 4351′, respectively, and relatively reducing the width of each of the first base 4100′ to which the second link 4330′ is rotatably connected and the second base 4200′ to which the third link 4350′ is rotatably connected, and with regard to the specific configuration of the moving part 4333′, by point-contacting the protrusions 4333′cl formed on one surface of the friction reduction part 4333′c to the first base 4100′, the second link 4330′, specifically, the second link body 4331′ and the first base 4100′ can be prevented from being damaged due to contact or friction therebetween, and the contact area between the friction reduction part 4333′c and the first base 4100′ can be minimized, and thus a detailed description will be omitted in the overlapping range.

Although the embodiments of the present disclosure have been described in detail with reference to the accompanying drawings, the present disclosure is not necessarily limited to the embodiments and various modifications may be made without departing from the technical idea of the present disclosure. Therefore, the embodiments disclosed in the present disclosure are intended to illustrate and not to limit the technical ideas of the present disclosure, and the scope of the technical idea of the present disclosure is not limited by these embodiments. Therefore, the above-described embodiments should be considered as only illustrative in all aspects and not for purposes of limitation. The scope of the present disclosure should be interpreted by the appended claims and encompass all technical ideas falling within the scope of the appended claims.

According to the present disclosure, with regard to the specific configuration of the lifting and lowering unit coupled to the arm massage unit, by adjusting the position of the second base with respect to the first base by the position adjustment unit, the position of the arm massage unit can be adjusted.

In addition, as the interval between the first base and the second base is changed by the position adjustment unit, the second base and the arm massage unit coupled to the second base can be disposed to be inclined with respect to the first base by a preset angle.

In addition, as not only the height of the arm massage unit is adjusted, but also the inclination along with the height of the arm massage unit is adjusted, the arm of the user using the massage apparatus can have an ergonomically comfortable position.

However, the effects of the present disclosure are not limited to the above-described effects and include effects that may be easily understood by those skilled in the art to which the present disclosure pertains from the present specification and the accompanying drawings.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A massage apparatus comprising:
a body massage unit configured to massage at least a part of a body of a user;
an arm massage unit disposed on a side portion of the body massage unit and configured to massage an arm of the user; and
a lifting and lowering unit disposed on a lower portion of the arm massage unit and configured to adjust a position of the arm massage unit.

2. The massage apparatus of claim 1, wherein the lifting and lowering unit moves the arm massage unit in at least one of an upward direction and a downward direction of the arm massage unit.

3. The massage apparatus of claim 2, wherein the lifting and lowering unit is disposed in at least a partial region of an entire lower region of the arm massage unit.

4. The massage apparatus of claim 3, wherein the lifting and lowering unit is disposed in a lower region of the arm massage unit between one end and another end of the arm massage unit.

5. The massage apparatus of claim 1, wherein
the lifting and lowering unit includes:
a first base disposed inside the body massage unit;
a second base which is disposed to face the first base and to which the arm massage unit is coupled;
a position adjustment unit disposed between the first base and the second base and capable of adjusting a position of the second base with respect to the first base; and
a driving unit configured to transmit power to the position adjustment unit.

6. The massage apparatus of claim 5, wherein, as an interval between the first base and the second base is changed by the position adjustment unit, the second base is disposed to be inclined with respect to the first base by a preset angle.

7. The massage apparatus of claim 5, wherein the arm massage unit is couplable to another side of the second base, which is opposite to one side of the second base facing the first base.

8. The massage apparatus of claim 5, wherein
the position adjustment unit includes:
a first link rotatably connected to the first base;
a second link configured to connect the first base and the second base to each other and disposed to cross the first link; and
a third link configured to connect the first link and the second base.

9. The massage apparatus of claim 8, wherein another side of the second link, which is opposite to one side of the second link connected to the second base, is linearly movable on the first base.

10. The massage apparatus of claim 8, wherein
the first link includes:
a pair of first link bodies disposed to face each other; and
a support configured to connect the pair of first link bodies.

11. The massage apparatus of claim 8, wherein the position adjustment unit further includes an interval maintaining part disposed to be contactable between the first link and the second link and configured to separate the first link and the second link by a present interval.

12. The massage apparatus of claim 8, wherein
a stopper is provided on another side of the first link, which opposite to one side of the first link connected to the first base, and
a placing groove is formed in one surface of the second base facing the first base to allow the stopper to be placed therein.

13. The massage apparatus of claim 5, wherein the driving unit transmits the power so that the position adjustment unit is movable on the first base.

14. The massage apparatus of claim 5, wherein the driving unit is coupled to the first base.

15. The massage apparatus of claim 5, wherein the driving unit generates the power in a hydraulic or pneumatic manner.
